(19) United States
(12) Patent Application Publication
(10) Pub. No.: US 2003/0089753 A1
(43) Pub. Date: May 15, 2003

(54) Glass edging method and tool therefor

(76) Inventor: Joseph Hang, Calabasas, CA (US)

Correspondence Address: Irving Keschner, Suite 1150, 21515 Hawthorne Boulevard, Torrance, CA, 90503, US

(21) Appl. No.: 09/948,357

(22) Filed: Sep. 10, 2001

(51) Int. Cl. C03B 33/12; B26F 3/02

(52) U.S. Cl. 225/1; 225/93

(57) ABSTRACT

An edging method using a special tool for providing a visually attractive glass design. The tool chips the flat surface around the glass perimeter edge to create arc shaped concave gaps. In addition, fine torn lines at the rim of each concaved gap are created that provide the visual effect of luminous diamonds when viewed from the opposite side of the glass. The tool is designed so that each of its critical points are accurately positioned to provide a quick and tearing effect to the desired edge location. The design enhances the aesthetic appearance of the glass and provides a unique visual appearance when the glass is viewed at different angles.

### BACKGROUND OF THE INVENTION

1. Field of the Invention

The present invention provides a method and apparatus for edging glass in a manner that the glass provides an enhanced visual effect to those looking at the glass.

2. Description of the Invention

Glass is widely accepted for decorative purposes due to its transparent property and its desired hardness required for fabrication and, as a result, is extensively used for all kind of products such as doors, windows and tabletops. However, glass is also very brittle and can be easily broken. Thus, most fabricators are reluctant to perform any work around the perimeter or edge area of the glass in order to avoid damage and hence increase production costs. Thus the edge design on most of the glass products on the market today only are rounded and then beveled for safety reasons. There are very few glass products with extensive design patterns around the edge of the glass perimeter.

A glass product 10 with the standard edge design pattern currently being marketed is illustrated in FIG. 1. The method for providing the design involves grinding the glass edge against a rotating sand wheel that evenly removes a portion of the edge to form the pattern. Detail A and sections A-A and B-B shows surface 12 as even and smooth. There will not be any special or noticeable effects other than the glass edge having a wave-like pattern design when viewing glass product 10 from any direction. In addition, the production rate using this method is very slow due to the fact that the speed of the rotating sand wheel is very slow in order to minimize the rotational force that may crack or break the glass. Machines are also available on the market with multiple wheels that simultaneously create several gaps, thus significantly reducing the time required. However, the size of the gaps is harder to control with multiple wheels since the pressure must be applied evenly to the glass against each of the wheels. Therefore, this type of glass product with the edge work is very expensive and not widely accepted by consumers.

What is thus desired is to provide a technique for edging glass in a manner such that desirable visual effects are provided at relatively low cost.

### SUMMARY OF THE INVENTION

The present invention provides an edging method using a special tool for providing a visually attractive glass design. The tool chips the flat surface around the glass perimeter edge to create a predetermined number of arc shape concave gaps. In addition, fine torn lines at the rim of each concaved gap are created that provide the visual effect of luminous diamonds when viewed from the opposite side of the glass. The tool is designed so that each of its critical points are accurately positioned to provide a quick and a tearing effect to the desired edge location. The design enhances the aesthetic appearance of the glass and provides a unique visual appearance when the glass is viewed at different angles by providing unique gaps around the glass edges.

The invention effectively eliminates damages during fabrication of the glass edge thus reducing fabrication costs and thereby providing a reasonable and affordable price for the ultimate purchaser.

### DESCRIPTION OF THE DRAWING

For a better understanding of the present invention as well as other objects and further features thereof, reference is made to the following description which is to be read in conjunction with the accompanying drawing therein:

FIG. 1 illustrates a conventional glass edge design pattern;

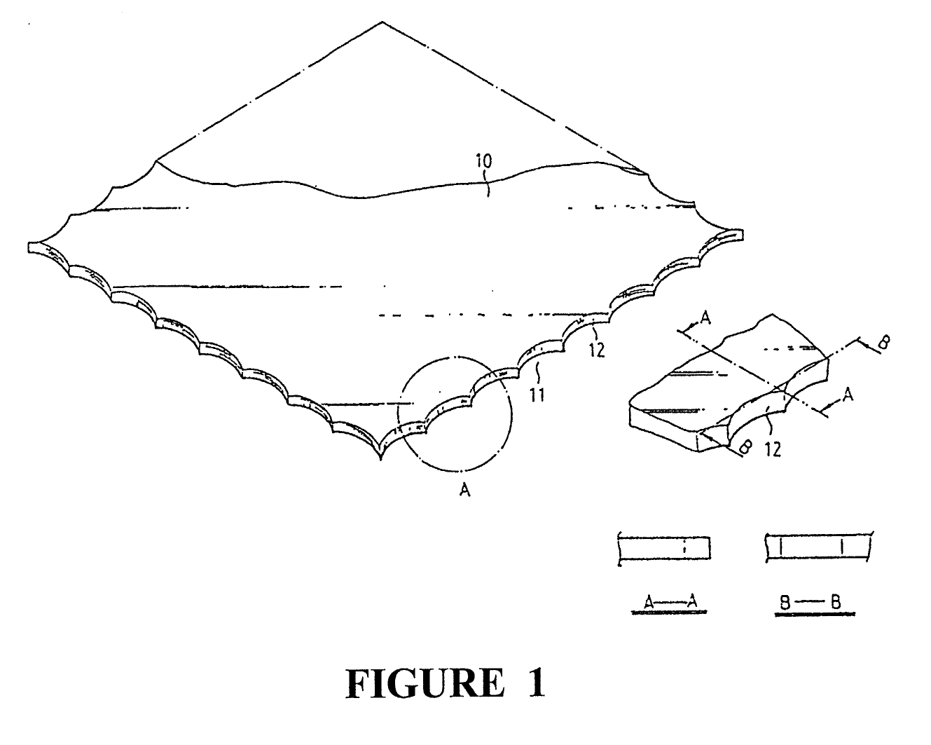

FIG. 2 is the glass edge design pattern produced by the tool of the present invention;

FIG. 3 is a perspective view of the tool of the present invention;

FIG. 4 is an exploded view of the tool shown in FIG. 3;

FIG. 5 illustrates the fabrication set up using the tool of the present invention; and

FIGS. 6(a) and 6(b) illustrate how the glass edge design of the present invention can be used to enhance the aesthetic appearance of an ordinary piece of glass.

### DESCRIPTION OF THE INVENTION

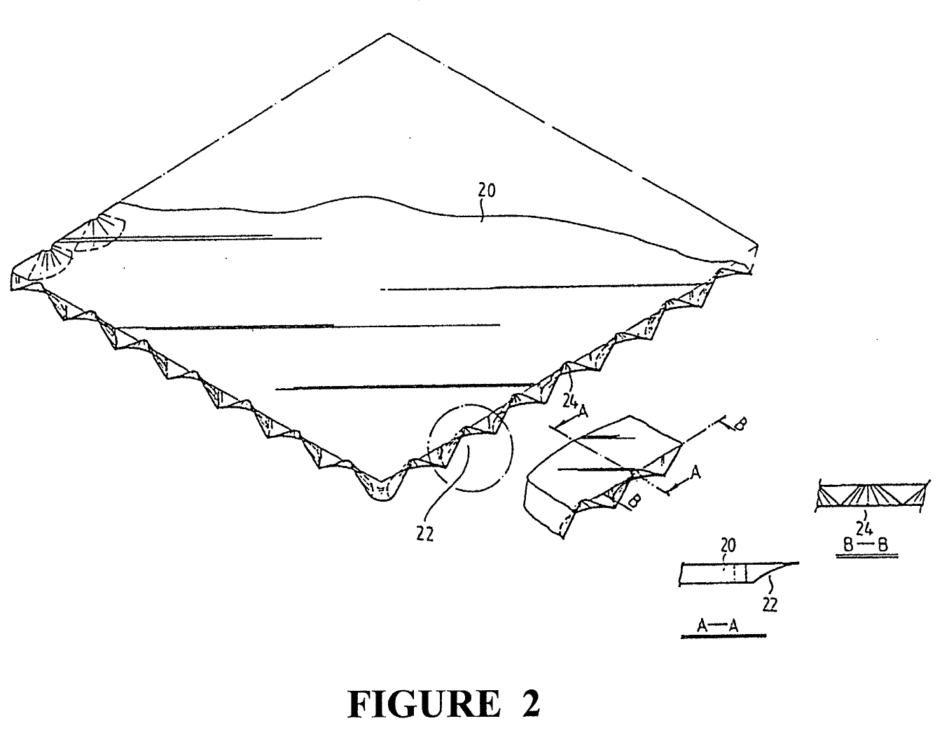

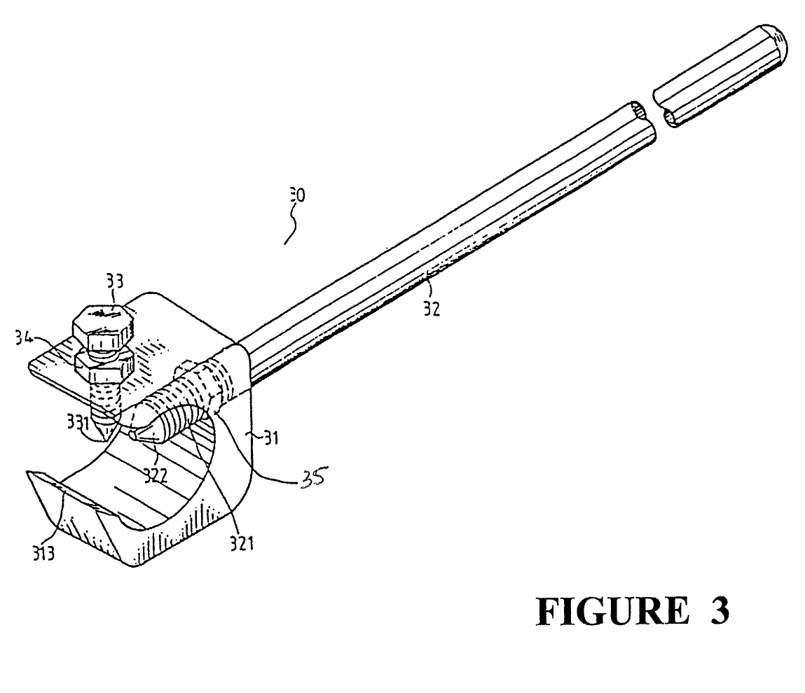

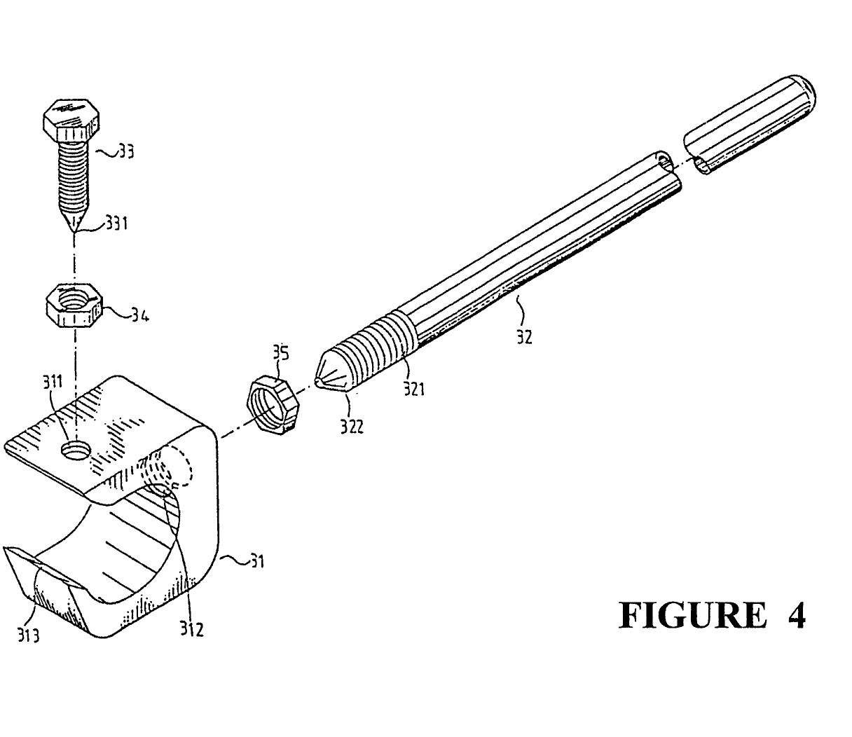

Referring now to FIG. 2, a glass substrate 20 has arc shaped concave gaps 22 and non-symmetrical fine torn lines 24 formed on the edge thereby using the special tool 30 shown in FIGS. 3 and 4.

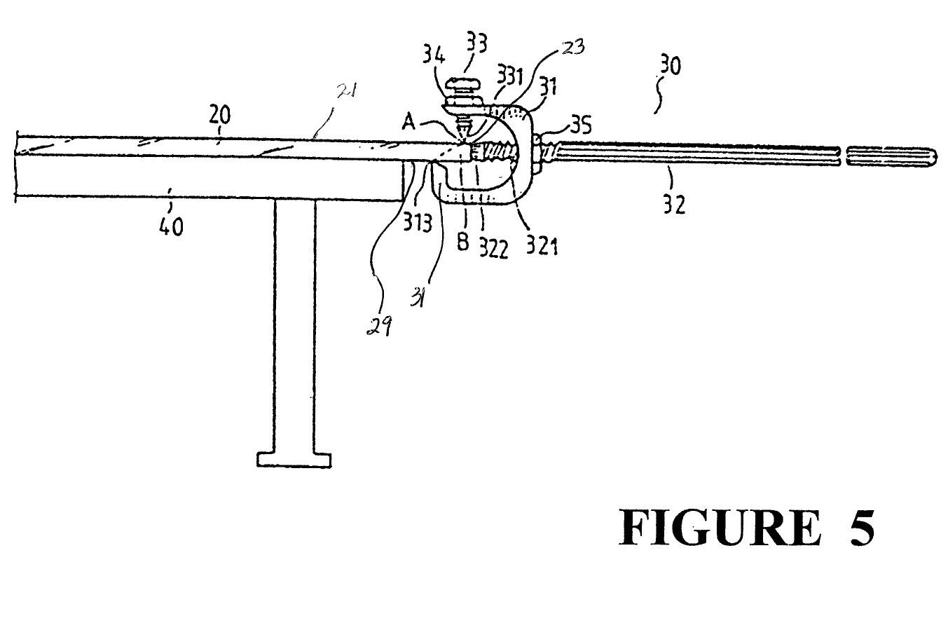

Tool comprises a “C” shape main body 31, extended rod portion 32, screw 33 and nut 34 and 35. Main body 31 has two threaded holes 311 and 312 on the top and side for screw 33 and rod 32, respectively. The vertical position of screw 33 is set by nut 34 and the rod horizontal position is set by nut 35. During fabrication of glass substrate 20, the left side sharp portion 313 of main body 31 clips on the bottom side of glass 20 at the location to be edged (FIG. 5). The threaded portion 321 of rod 32 with the nut 35 in place screws into the right side threaded hole 312 of the main body 31 until the tip 322 touches against the edge of glass 20 (FIG. 5). The screw 33 with the nut 34 in place screws into the top of threaded hole 311 of body 31 until the point 331 touches the top surface 21 of glass substrate 20.

Referring to FIG. 5, the first step of the method of the present invention is to place glass substrate 20 on top of table, or platform, 40 with the edge to be processed slightly extended beyond platform 40 as illustrated. The proper tool size is selected according to the thickness of the processing glass substrate 20 (Table 1 provides examples of typical tool dimensions in centimeters). Edge 313 of glass edging tool 30 then clips onto the extended edge of glass substrate 20. Screw 33 is adjusted until rod 32 is at an angle of approximately 10 degrees above top surface 21 and the left side shape portion 313 is evenly touching the bottom of glass substrate 20. Rod 32 is adjusted to a predetermined distance between point 331 and edge 23 of glass substrate 20 according to the thickness of substrate 20 and the desired gap size (Table 2 provides examples of typical distance/gap size dimensions for a particular thickness of substrate 20 in millimeters). Rod 32 and screw 33 are then secured by tightening nuts 35 and 34, respectively. Although the size of the gap can be varied, the shape remains concave. With one hand of the fabricator holding glass substrate 20 and the other hand pressing the rod 32 in a downward motion, glass substrate 20 is chipped between contact point A and tip 322 forming a geometrical arc shaped gap (B) while edge 313 isolates the breakage within the desired location (the pressure on point 331 and tip 332 creates a tearing effect). The surface of tool tip 322 determines the concave gap shape. After the initial arc shaped gap is formed, edging tool 30 is moved to an adjacent position and the process is repeated. The number of gaps formed are selected in accordance with the desired design pattern.

The glass edging method described hereinabove also provides a tearing effect on the processing edge 23 that leaves fine torn lines 24 on the arc shaped concaved gaps 22. The fine torn lines 24 are non-symmetrically distributed on the gap surface to create the desired results. The tearing effect leaves uneven length size fine torn lines at the rim of each concaved gap.

The present invention thus provides ordinary glass with a spectacular visual effect, the fabrication method being simple and cost effective.

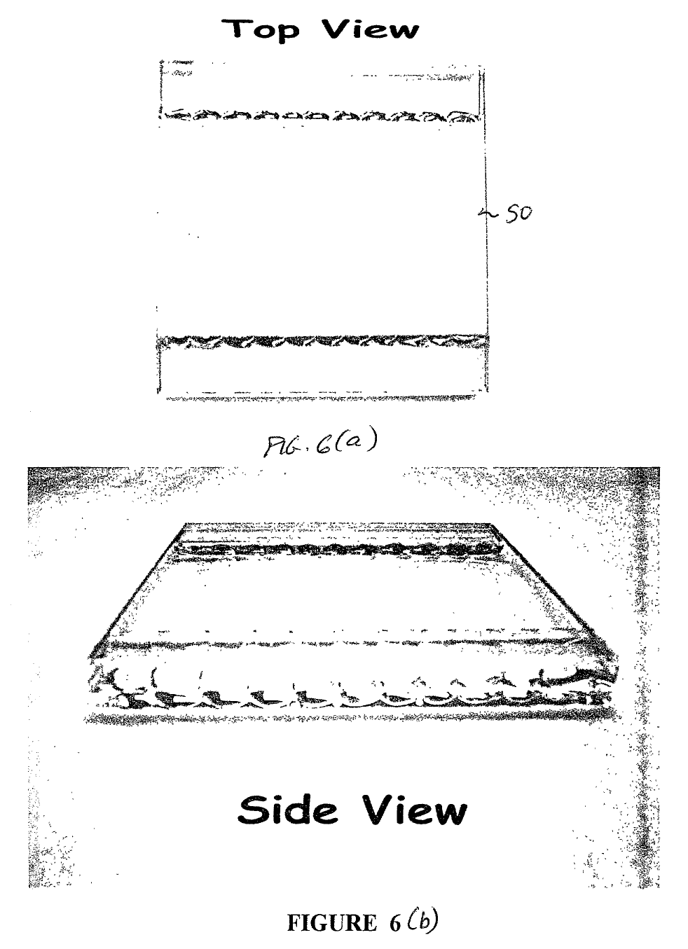

The edge design and its special effect formed in accordance with the teachings of the present invention can be optimized by adhering a strip of the specially formed edged glass to the bottom of ordinary glass 50 as shown in FIGS. 6(a) and 6(b). This arrangement provides visibility of the edged pattern and its specula luminous effect from both the top and side of the glass 50.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

TABLE 1

| THICKNESS | | | | | | | | | | | | | | | | | | |
|---|---|---|---|---|---|---|---|---|---|---|---|---|---|---|---|---|---|---|
| (m/m) | A | B | C | D | E | F | G | H | I | J | K | L | M | N | O | P | Q | R |
| 3 | 2 | 1 | 2.5 | 2.4 | 1.2 | 1.2 | 0.5 | 0.6 | 0.5 | 15.5 | 1 | 4 | 4 | 4 | 1 | 5 | 1 | 0.5 |
| 5 | 4.5 | 1.5 | 4.1 | 4.6 | 2.2 | 2.3 | 0.5 | 0.8 | 0.8 | 19.6 | 1.2 | 4 | 6 | 4 | 1.5 | 7 | 1.4 | 0.5 |
| 6 | 4.5 | 7.5 | 4.1 | 4.6 | 2.2 | 2.3 | 0.5 | 0.8 | 0.8 | 19.5 | 1.2 | 4 | 6 | 4 | 1.5 | 7 | 1.4 | 0.5 |
| 8 | 4.5 | 1.5 | 4.1 | 4.6 | 2.2 | 2.3 | 0.5 | 0.8 | 0.8 | 19.5 | 1.2 | 4 | 6 | 4 | 1.5 | 7 | 1.4 | 0.5 |
| 10 | 5 | 2 | 5.8 | 6 | 3 | 3.5 | 0.8 | 1.0 | 1.2 | 31.5 | 1.2 | 4 | 9 | 5.5 | 1.8 | 8 | 1.4 | 0.8 |
| 12 | 5 | 2 | 5.8 | 6 | 3 | 3.5 | 0.8 | 1.0 | 1.2 | 31.5 | 1.2 | 4 | 9 | 5.5 | 1.8 | 8 | 1.4 | 0.8 |
| 15 | 8 | 2 | 8 | 9 | 3.5 | 4.8 | 0.8 | 1.2 | 1.5 | 32.5 | 1.5 | 5 | 9 | 6.5 | 2 | 9 | 1.5 | 0.8 |
| 19 | 8 | 2 | 8 | 9 | 3.5 | 4.8 | 0.8 | 1.2 | 1.5 | 32.5 | 1.5 | 5 | 9 | 6.5 | 2 | 9 | 1.5 | 0.8 |

TABLE 2

| GLASS | 331 to 23 | | 331 TO 23 | |
|---|---|---|---|---|
| THICKNESS | DISTANCE | GAP SIZE | DISTANCE | GAP SIZE |
| 3 | 1 | 9-12 | 0.8 | 4-6 |
| 5 | 1.5 | 18-22 | 1.3 | 8-10 |
| 6 | 1.7 | 24-27 | 1.5 | 10-12 |
| 8 | 2 | 30-35 | 1.7 | 12-15 |
| 10 | 3 | 40-45 | 2.5 | 15-17 |
| 12 | 3.1 | 50-55 | 2.7 | 17-20 |
| 15 | 3.2 | 55-60 | 2.8 | 20-23 |
| 19 | 3.5 | 65-70 | 3 | 24-27 |

What is claimed is:

1. A method of edging a glass substrate comprising the steps of:
providing a glass substrate having at least one edge;
placing said glass substrate on the surface of a platform with said edge extending beyond said platform;
placing a first tip of a cutting tool in contact with the top surface of said glass substrate adjacent said extended edge; a second tip of said tool contacting the bottom surface of said glass substrate; said cutting tool having a horizontally extending handle member; and
moving said handle member in a downward motion thereby chipping glass from said contact point on the top surface of said glass substrate, said second tool tip forming an arc shaped gap in a predetermined area.

2. The method of claim 1 wherein said second tool tip limits the chipping within said predetermined area.

3. A glass edging tool comprising:
a C-shaped main body member having a first opening formed in a first portion of said body;
a rod member having a first tip portion, said rod member extending through said first opening;
an adjustable screw member having a second tip portion extending through a second opening formed in a second portion of said body member; and
a cutting portion formed on the edge of a third portion of said body member.
